(19) United States
(12) Patent Application Publication
(10) Pub. No.: US 2002/0163421 A1
(43) Pub. Date: Nov. 7, 2002

(54) Personal fingerprint authentication method of bank card and credit card

(76) Inventors: Po-Tong Wang, Taipei City (TW); Sheng-Ming Wu, Taipei City (TW)

Correspondence Address: Po-Tong WANG, PO Box 82-144, TAIPEI, TW

(21) Appl. No.: 09/849,279

(22) Filed: May 7, 2001

(51) Int. Cl. G06T 1/00; H04Q 1/00; H04B 1/00; G08B 29/00

(52) U.S. Cl. 340/5.83

(57) ABSTRACT

This invention represents a method of bank card and credit card with fingerprint authentication for identifying whether a user is a registered owner of the card. The reference fingerprint data will be digitized and stored in an IC chip or stored on a magnetic strip of a bank card and a credit card. Therefore, this invention can identify the correct user of the bank card or the credit card by collating the measured fingerprint data with the reference fingerprint data via a fingerprint ATM terminal or a fingerprint reading device of the credit card. It could prevent the illegal use of these cards and heavy financial problems of issuing banks.

### BACKGROUND OF THE INVENTION

It is a great popularity in economic activities that people use bank cards and credit cards to finish business transaction. The user can withdraw cash from local ATM terminals or indicated automated tellers in other countries because of global financial on-line connection. However, illegal use of the cards by a third party has become a big problem. These situations could result in the great loss of money of the user and banks. Counterfeiting of credit cards and unauthorized transactions by third parties have also become serious problems. There is no password of the credit card and the user's signature is easily imitated; therefore, it is difficult to identify whether the cardholder is the registered owner of the card. In addition, more and more people do business transactions or e-commerce over the Net. Therefore, in response to the need for enhancing security and personal identification, biometric techniques of verification utilize personal specific physical traits and unique biometric characteristics to make individual identification.

These non-transferable unique biometric characteristics include DNA, iris, fingerprint, face and voice patterns. The DNA and the iris of the eye perform verification with very high reliability; however, their costs are higher than other biometric systems. Consequently, other biometric systems of identification are more popular to be utilized in the market over many years. Each biometric system has different memory size, feature extraction, verification rate and equipment cost; therefore, not all of these biometric systems are convenient to market.

Regarding the equipment of face recognition, it needs costly equipment such as digital camera, prism and illuminant. On the contrary, fingerprint verification needs a cheap sensor device and speaker verification only needs a microphone. Additionally, regarding the memory size of the face, its feature size is about 1,000 bytes. The feature size of a template fingerprint is about 300 bytes and the voice pattern is only 100 bytes. Therefore, the memory size of the face is so big that it could not be stored on a magnetic strip of the card. It is also not conveniently utilized during e-commerce transactions because its large memory size will enlarge the transaction time and slow down the transmission speed.

Furthermore, the effect of face recognition could be influenced by angles, light source and other decorations. The feature extraction of fingerprints is more reliable than faces and voice pattern. Therefore, the accuracy rate of fingerprint verification is higher than others. Also, fingerprint verification has become the major law-approved biometrics application technology to provide high security standards during financial transactions and e-commerce.

### SUMMARY OF THE INVENTION

It is an object of the present invention to provide a bank card and a credit card with fingerprint authentication function. The present invention performs fingerprint verification to identify whether the user is a registered owner of the card. According to the fingerprint is unique and reliable, fingerprint characteristic data will be stored in an IC chip or on a magnetic strip of a bank card and a credit card. The next step is to identify the correct user of the bank card or the credit card by collating the measured fingerprint data with the reference fingerprint data via a fingerprint ATM terminal with a fingerprint reading device. It is a further object of the present invention to provide individual financial security and prevent misuse of cards.

### BRIEF DESCRIPTION OF THE DRAWINGS

FIG. 1 is a top view schematically showing the present invention. FIG. 2 is another top view schematically showing the present invention.

FIG. 3 is a flow chart to illustrate how to perform a bank card with fingerprint authentication.

FIG. 4 is a flow chart to illustrate how to perform a credit card with fingerprint authentication.

### DETAILED DESCRIPTION OF THE PREFERRED EMBODIMENT

Illustration of the following serial numbers:

1. The user

2. Fingerprint verification device

3. A ATM terminal

4. Card reading apparatus

5. The user applies a fingerprint bank card to the bank and places more than one fingerprint on the sheet form or captures fingerprints via fingerprint reading device in a digital form.

6. The bank card issuing center will check the personal information to confirm the user's identity. Fingerprint characteristic data about 300 bytes will be encrypted and digitized to store on a magnetic strip or in index position of an IC chip of the bank card.

7. After the application is approved, the bank will send the fingerprint bank card to the user.

8. The user opens the bank card according to the instructions from the bank.

9. Banks set fingerprint ATM terminals or add fingerprint verification device and revised software at original ATM terminals.

10. Each bank card has been changed into a fingerprint bank card and each ATM terminal has become a fingerprint ATM terminal.

11. The user applies a fingerprint credit card to the bank and places more than one fingerprint on the sheet form or captures fingerprints via fingerprint reading device in a digital form.

12. The credit card issuing center will check the personal information to confirm the user's identity. Fingerprint characteristic data about 300 bytes will be encrypted and digitized to store on a magnetic strip or in the index position of an IC chip of the credit card.

13. After approval, the credit card issuing center will send the fingerprint credit card to the user.

14. The user opens the fingerprint credit card according to the instructions from the issuing center.

15. Each affiliated store uses fingerprint reading device. When the cardholder uses the fingerprint credit card to purchase goods at the store, he (she) has to place his (her) fingerprint on the device to carry out a transaction.

16. Each credit card has been changed into a fingerprint credit card and each affiliated store has set fingerprint reading device.

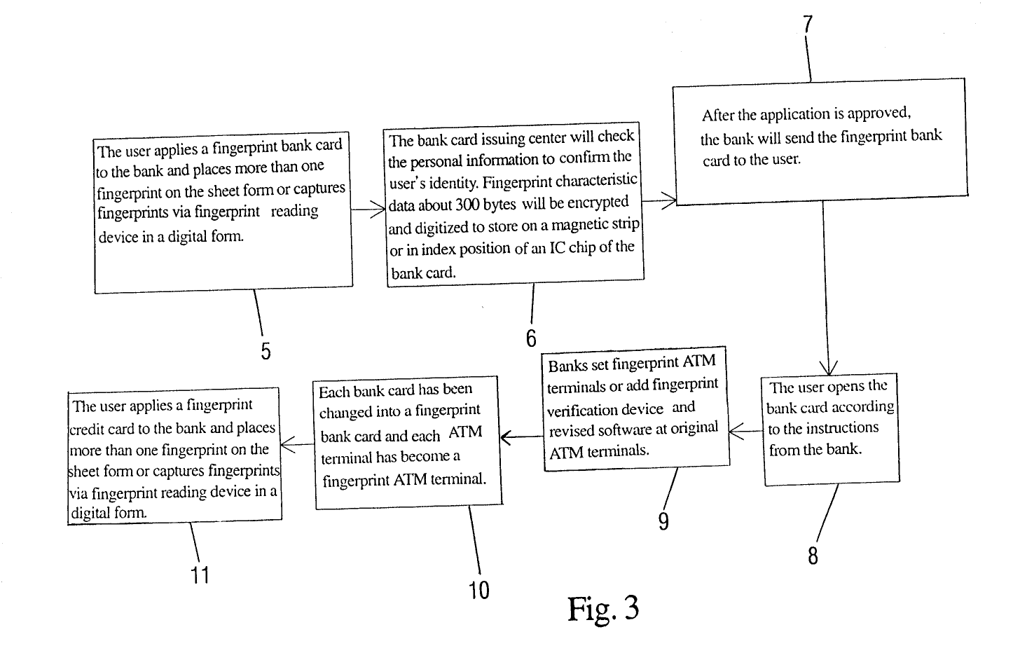

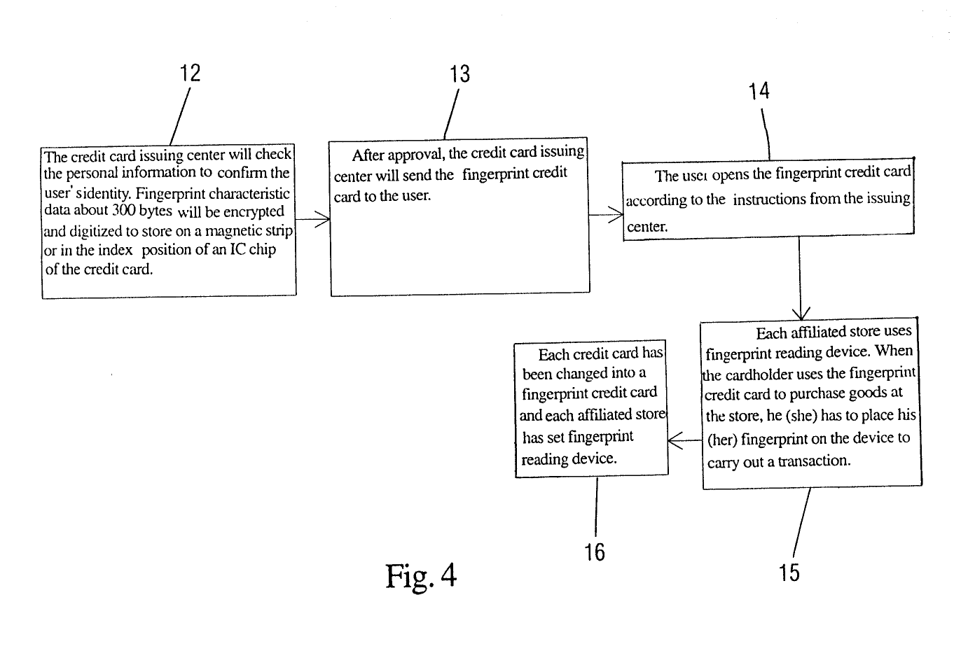

This invention adopts the fingerprint authentication method, which is the major law-approved biometrics application technology to identify whether the user is a registered owner of the bank card or the credit card. Fingerprint characteristic data will be encrypted and stored on a magnetic strip or in index position of an IC chip of the cards. FIG. 3 and FIG. 4 will show how to identify the user by using a fingerprint bank card or a fingerprint credit card.

As seen in FIG. 3, the following description will show how to perform authentication using the bank card with fingerprint authentication function.

A. The user applies a fingerprint bank card to the bank and places more than one fingerprint on the sheet form or captures fingerprints via fingerprint reading device in a digital form5. The user has to go to the bank for applying the bank card himself; therefore, the fingerprint characteristic data from the cardholder could not be forgery or fake.

B. The bank card issuing center will check the personal information to confirm the user's identity. Fingerprint characteristic data about 300 bytes will be encrypted and digitized to store on a magnetic strip or in index position of an IC chip of the bank card6.

C. After your application is approved, the bank will send the fingerprint bank card to the user7.

D. The user opens the fingerprint bank card according to the instructions from the bank8.

E. Banks set fingerprint ATM terminals or add fingerprint verification device and revised software at original ATM terminals9. But the user still can enter the password to withdraw cash from original ATM terminals. If the user wants to withdraw cash from fingerprint ATM terminals, he (she) has to get approved for the fingerprint authentication.

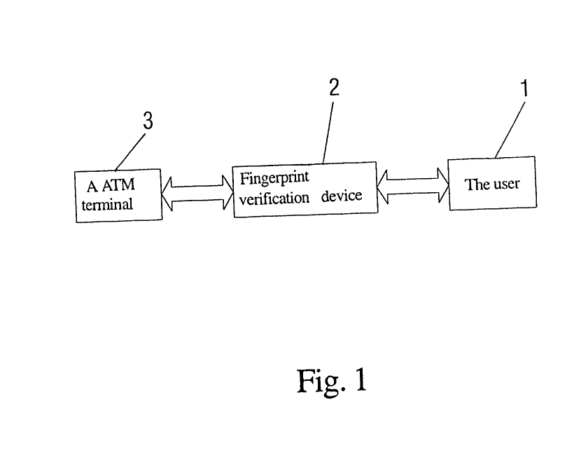

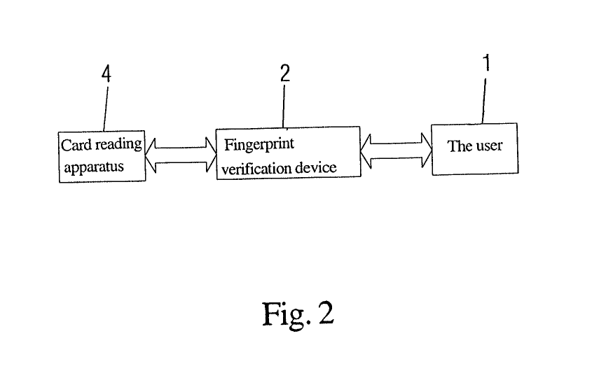

F. Each bank card has been changed into a fingerprint bank card and each ATM terminal has become a fingerprint ATM terminal10. As seen in FIG. 1, the user1 can withdraw money from ATM terminals3 by getting approved for the fingerprint authentication via fingerprint verification device2, but not by entering the password. It can prevent illegal users to use the cards and confirm that the user is the correct card owner.

As seen in FIG. 4, the following description will show how to perform authentication using the credit card with fingerprint authentication function.

A. The user applies a fingerprint credit card to the bank and places more than one fingerprint on the sheet form or captures fingerprints via fingerprint reading device in a digital form 11. When the user get the fingerprint credit card from the issuing bank, the issuing bank will keep the user's personal information with his (her) fingerprint characteristic data. Therefore, the data won't be forgery or illegal used by others.

B. The credit card issuing center will check the personal information to confirm the user's identity. Fingerprint characteristic data about 300 bytes will be encrypted and digitized to store on a magnetic strip or in the index position of an IC chip of the credit card12.

C. After approval, the credit card issuing center will send the fingerprint credit card to the user13.

D. The user opens the fingerprint credit card according to the instructions from the issuing center14.

E. Each affiliated store uses fingerprint reading device. When the cardholder uses the fingerprint credit card to purchase goods at the store, he (she) has to place his (her) fingerprint on the device to carry out a transaction15. However, the user still can use the credit card to carry out a transaction by signing his (her) name at a store where is no fingerprint verification device.

F. Each credit card has been changed into a fingerprint credit card and each affiliated store has set fingerprint reading device. As seen in FIG. 2, the user1 uses the fingerprint credit card to carry out a transaction by using the credit card reading apparatus4 and getting approved via fingerprint authentication device2, but not by signing his (her) name. The affiliated stores, issuing banks and cardholders will not worry about illegal uses and counterfeiting of the cards.

In conclusion, the present invention has the following advantages:

1. Fingerprint authentication is one of the digital biometric verification systems (such as voiceprint, iris, face recognition and DNA) and it has become the major law-approved biometrics application technology to identify a person.

2. The fingerprint is unique and reliable; therefore, it can detect fake fingers and prevent illegal uses during business transaction by utilizing fingerprint feature vector verification and extraction algorithms.

3. Fingerprint image input device will lower prices in the next few years and the need of authentication in the Net is increasing day after day. Therefore, a global fingerprint authentication system will become more importance of online commerce soon.

4. This invention presents an easy use mechanism that users can do business transaction and online commerce with high security standards.

5. This invention presents a method with low cost and high probability of authentication process.

1. A personal authentication method of bank card and credit card with fingerprint authentication function comprising:
bank card or a credit card main body;
memory means for encrypting and storing fingerprint characteristic data on a magnetic strip or in index position of an IC chip of the card when the user applies for a bank card or a credit card;
fingerprint match means for collating the measured fingerprint data with the reference fingerprint data via a fingerprint ATM terminal or a fingerprint reading device of the credit card; and
authentication means for identifying whether the user is a registered owner of the card.

2. The method of claim 1 wherein said the bank card with fingerprint authentication function comprises steps of:
a. application means for placing more than one fingerprints on the sheet form or captures fingerprints via fingerprint reading device in a digital form when the user applies a fingerprint bank card to the bank; wherein
b. check means for checking the personal information to confirm the user's identity;
c. encryption means for encrypting and storing fingerprint characteristic data about 300 bytes or much less on a magnetic strip or in index position of said IC chip;
d. approval means for getting approved and receiving said fingerprint bank card from said issuing bank;
e. open means for starting to use said fingerprint bank card according to the instructions from said bank;
f. revise means for changing all bank cards into said fingerprint bank cards, and means for changing all ATM terminals into said fingerprint ATM terminals; and
g. verification means for confirming the user is the correct card owner.

3. The method of claim 1 wherein said the credit card with fingerprint authentication function comprises steps of:
a. application means for placing more than one fingerprints on the sheet form or captures fingerprints via fingerprint reading device in a digital form when the user applies a fingerprint credit card to the credit card issuing bank; wherein
b. check means for checking the personal information to confirm the user's identity;
c. encryption means for encrypting and storing fingerprint characteristic data about 300 bytes on a magnetic strip or in index position of said credit card;
d. approval means for getting approved and receiving said fingerprint credit card from said bank;
e. open means for starting to use said fingerprint credit card according to the instructions from said bank;
f. a fingerprint reading device, for utilizing by each affiliated store to identify the user when he(she) uses said credit card to carry out a transaction at said store; and
g. revise means for changing all credit cards into said fingerprint credit cards, and means for changing all credit card reading apparatus into the device with said fingerprint verification device.

4. The method of claim 1 wherein said encryption means for encrypting and storing personal fingerprint characteristic data on a magnetic or in a computer chip or both of them of said fingerprint bank card.

5. The method of claim 1 wherein said encryption means for encrypting and storing personal fingerprint characteristic data on a magnetic or in an IC chip or both of them of said fingerprint credit card.

6. The method of bank card and credit card with fingerprint authentication function as defined in claim 1, wherein said fingerprint verification device has been set in ATM terminals of bank cards or credit cards.

7. The method of bank card and credit card with fingerprint authentication function as defined in claim 1, wherein said fingerprint verification device has been set in said bank card and credit card reading apparatus.
